(19) United States
(12) Patent Application Publication
(10) Pub. No.: US 2004/0127120 A1
(43) Pub. Date: Jul. 1, 2004

(54) High strength polymeric composite laminate for use as a roofing underlayment

(76) Inventors: Natalino Zanchetta, Reno, NV (US); Shaik Mohseen, Mountain Top, PA (US)

Correspondence Address: David I. Roche, BAKER & McKENZIE, 130 E. Randolph Drive, Chicago, IL, 60601, US

(21) Appl. No.: 10/334,871

(22) Filed: Dec. 31, 2002

(51) Int. Cl. B32B 27/12; B32B 27/04; B32B 27/02; B32B 5/02; B32B 27/32; B32B 5/26; D04H 3/16

(52) U.S. Cl. 442/45; 442/35; 442/38; 442/41; 442/43; 442/46; 442/49; 442/401; 442/394; 442/398; 442/149; 442/150

(57) ABSTRACT

A high strength polymeric composite laminate that has enhanced design features to perform as a roofing underlayment material for use in conjunction with modified bituminous materials such as APP or SBS membranes, as well as shingles, tiles, metal and other roof coverings.

### BACKGROUND OF THE INVENTION

This invention relates to polymeric composite laminate structures used in roofing membranes adapted for the waterproofing and sealing of substrate structures, particularly in roofing applications and to the method of manufacturing such membranes. More particularly, the present invention is the field of ‘roofing underlayments’, which are widely used in both residential and commercial applications.

Roofing underlayment materials are used in roofing systems such as modified bituminous roofing membranes as well as shingles, tiles, slates, cedar and metal roofing. Some underlayments such as asbestos fiber roofing felts were used during the early part of the 20^{th} century but are no longer used due to health hazards associated with asbestos fibers. The most commonly used underlayment is asphalt-saturated roofing felt, commonly known as No. 15, No. 30 or No. 50 felt. These have been in use for a very long time and are the least expensive form of underlayment available. Roofing felt is made from a base sheet made of paper coated with filler-modified asphalt and as such is very inexpensive. Several roofing companies produce such materials.

The main objective of using felt is to provide a protective barrier on the deck when applying roofing membranes by means of hop mopping, torching or self-adhesive applications. Several building code bodies such as Miami Metro Dade County dictates the use of slip sheet in all roofing applications under its jurisdiction. This is to ensure that the roof deck such as plywood is not damaged during ‘roof tear off’ when replacing the roof. During installation of a roof, roofing underlayments are attached to the wood deck by ‘mechanically fastening’ using roofing nails or staples. Based on the roof specifications, another course of material such as No. 90 felt is applied on top of the No. 15 or No. 30 felt via hot asphalt mopping, or a self-adhesive membrane is ‘adhered’ to the No. 15 or No. 30 felt. Tiles or shingles are attached to the upper surface of the exposed membrane via mechanical attachments or using adhesive foam.

Roofing felts have been in short supply periodically and due to supply-demand factors, the price of felt has continued to rise over the years. Interestingly, felts have several limitations. It is well known that roofs undergo significant expansion and contraction as they heat and cool throughout the day. Because of such thermal cycling, felts experience shrinkage when exposed to the elements and exhibit deterioration in a relatively short period of time. Moreover felts are not watertight when roofing nails or staples are driven through them, making it necessary to cover the felt underlayment with the next course of roofing material immediately upon installation of the felt to the deck.

These limitations, coupled with frequent shortage of felt underlayments, have forced roofers and contractors to search for alternate materials. As an answer to this problem, there exist some underlayments that are non-asphaltic, which are usually a lamination of two or more film structures. These materials, known are as synthetic underlayments, have been gaining popularity since they are lighter and offer more coverage per roll than conventional felt and are vastly superior to felt in tensile and tear strength, in addition to being competitively priced against No. 30 felt. To summarize, synthetic roofing underlayments are gaining popularity due to their inherent advantages over conventional felt underlayments.

Some of the synthetic underlayments sold in the United States are Tri-Flex 30 (sold by Flexia Corporation), Titanium UDL (sold by Interwrap Corporation), Roof Guard (sold by Rosenlew, Finland) and Roofshield (Roof Shield USA L.L.C.). These materials are hybrids of two or more polymeric sheets that are laminated using adhesives or by heat welding. Tri-Flex 30 is a spunbonded polypropylene with a thin coating of polypropylene on both sides. Titanium UDL is a coated woven construction consisting of two layers of polypropylene film. Roof Guard is a multi-layered laminated polyethylene roofing underlayment. Roofshield is a porous spun bonded polypropylene fabric sold as an underlayment. Such products are lightweight, possess good tensile and tear strengths, offer excellent water resistance, do not wrinkle, rot or crack, and have good lay-flat properties.

### SUMMARY OF THE INVENTION

The present invention offers a hybrid polyolefinic multi-laminate roof underlayment manufactured using highly durable multiple structures and formulated with anti-skid protection on the top surface to provide significantly enhanced anti-skid protection. Such material far exceeds the physical requirements of conventional roofing felt in addition to offering other significant benefits to the end user. The salient features of such synthetic underlayments are the following: light weight and easy to handle, more coverage per roll, very high tensile and tear strengths, good ultraviolet resistant properties, anti-skid surfacing, excellent water shedding properties, wrinkle free, rot and insect resistant, pliable and flexible at low temperatures, excellent lay flat characteristics, and usable in hot and cold climatic conditions. Since the laminate of the present invention is approximately five times lighter than felt, fifteen times stronger than felt and has five times more coverage per roll than felt, it offers significant savings in time and labor during application, resulting in cost savings to the end user. Other advantages of such material are that it is environmentally friendly, relatively inexpensive, highly reliable, and does not involve additional time for installation of the roof. The composite laminate that is the subject of this invention has several unique design features that permits it to be used as an underlayment for self-adhesive membranes, tile roofs and metal roofs, as well as shingles.

Such composite material can be a lamination of multiple layers consisting of film, scrim and fabric materials. Film used is preferably a thin gauge sheet. Ultraviolet resistance may be imparted by including carbon black during the manufacture of such film. The material comprising the sheets may be either a low density or high density polyethylene (PE) or polypropylene (PP). Polyethylene and polypropylene films are used in a variety of applications including roofing and waterproofing materials. These films are usually very thin in the order of 8 microns (0.32 mils) to 20 microns (0.80 mils) and have some ultraviolet resistance by addition of black pigment. Moreover such polyolefinic films are relatively inexpensive. These film materials form the top (exposed) surface of the inventive laminate and it is therefore preferable that such materials possess skid resistant characteristics.

Scrim materials, which are widely used in the manufacture of bulk bags, are polyethylene or polypropylene based. These scrims are woven structures and therefore offer exceptionally high tensile and tear strengths. Such scrims can offer some UV protection as well by the addition of black pigments. The fabric used is commercially available polyester or polypropylene or polyethylene that is utilized in a variety of applications including roofing, furniture, etc. Such fabrics are non-woven and offer some skid resistance and UV protection and are non-wicking. These fabrics are lightweight, usually in the order of 22 grams per square meter to 40 grams per square meter, and are inexpensive. To avoid differential stresses arising from changes in temperature, the various substrates are preferably made of materials having similar or identical thermal expansion properties.

For purposes of the present invention, the preferred materials are polyethylene film (PE), polypropylene scrim, and polypropylene fabric. For the top surface layer, PE film is chosen over PP film for cost considerations. Polyethylene can be high density polyethylene (HDPE) or low density polyethylene (LDPE). HDPE has better UV resistance characteristics and higher temperature resistance than LDPE and therefore, HDPE is preferred over LDPE. HDPE film selected is black in color versus white or clear in order to have better UV resistance. Thickness of the film is very important because the film must not be too thin so as to deteriorate easily on the rooftop or be too thick that it can easily delaminate from the next layer. In addition, obtaining just the right thickness is important for cost reasons, it being wasteful to have more material than is required for the limited purposes served by the underlayment. Moreover if the next course of membrane to be applied is of self-adhering variety, the self-adhesive compound on the back side of the membrane has been observed to adhere easier to a thinner film. Based on these considerations, film thickness in the order of 0.8 mil (20 microns) is preferred for this application.

If the next course of material to be applied on top of the felt is a self-adhering membrane, it is important that the surface of such felt alternatives have a top surface to which self-adhesive material can be adhered to without the need for any external agents such as caulk or mastics or heat. It is noteworthy that HDPE film bonds very well to self-adhesive compounds. Cartenplast s.r.l. of Italy, Sipa of Italy, and PCL Packaging of Massachusetts are some of the sources of such thin gauge, high density polyethylene films. Since the film material will form the top layer of the inventive laminate, it is preferable that such film possesses anti-skid properties. One measure of skid resistance is coefficient of friction. Higher the coefficient of friction, greater the skid resistance. Incorporating additives in the film during its manufacture can increase coefficient of friction. In order to achieve a good bond between the top layer (film) and middle layer (scrim) using a minimum quantity of adhesive as bonding agent, it is preferred that surface energy of the film be at least 40 dynes/cm². Surface energy can be increased by corona treatment of the film. For this inventive laminate, a high COF (coefficient of friction), black color, 20 micron thick, dual side corona treated, high density polyethylene film is preferred.

Examples of self-adhered roofing membranes that are particularly suited to be adhered to the upper surface of the underlayment of the present invention, include APP (Atactic Polypropylene) and SBS (Styrene-Butadiene-Styrene) modified asphalt self-adhered membranes sold by the assignee of the present invention, SBS Modified bituminous self-adhered membranes sold by IKO Group under the trade name of RoofFast™, IMPERFLEX USA™ SBS modified bituminous self-adhered membranes sold by BITEC, Inc., Liberty SBS self adhering roofing membranes sold by GAF Corporation, and KwikRoof SBS self adhering roofing membranes sold by Ridglass Co. Also various commercially available self-adhering underlayments can be used in conjunction with the laminate of this invention.

For the middle layer, scrim is preferred. Scrim provides the required structural integrity to the final product such as high tensile and tear strengths and puncture resistance. Scrim can be based on polyester or polypropylene. Woven polyester scrims are hydrophilic in nature and as such any laminate using polyester scrims will wick water leading to potential failure of the underlayment. Woven polypropylene is hydrophobic and as such repels water leading to improved long term performance of the underlayment. Therefore a scrim based on polypropylene is preferred for this invention. The scrim consists of polypropylene fibers that are woven in longitudinal and transversal directions to yield a strong material. Scrims are typically classified by the number of yarns in each direction, which is directly related to the resulting strength of the product. A typical scrim will have between 8×5 squares per square inch and 12×12 squares per square inch. For the present invention, a scrim of 12×9.5 construction is preferred. BP Amoco of Georgia and Nichilon of Georgia are two sources of such woven polypropylene scrim. PP scrims of this construction are widely used in the manufacture of flexible intermediate bulk containers (FIBC), commonly referred to as ‘bulk bags’, are relatively inexpensive and are readily available. This polypropylene scrim that forms the middle layer is an ‘open weave’ material, which is not totally impervious. Hence it is essential to laminate another layer that forms a continuous bottom surface.

The chosen bottom surface is spun bonded fabric based on polypropylene. PP fabrics are lightweight, readily available and low in cost. These fabrics are used in a variety of applications including roofing membranes, furniture, etc. PP fabric selected for this lamination was of unit weight ranging from 22 to 30 grams/meter² in order to keep the overall weight of the product at a minimum. When the finished product is installed, the bottom surface comes into contact with the deck. If this bottom surface is too smooth, the material may tend to slide. Hence it is essential to have a coarser surface on the bottom of this laminate. Fabrics have a rough texture that provides a semblance of skid resistance. Spun Indo Jaya of Indonesia and Texbond of Italy are two sources of such lightweight fabrics. During manufacture of such fabrics, surfactants are added to aid in processing the material, Such additives can interfere with lamination of the fabric to the middle layer, i.e., polypropylene scrim, and hence it is important that the fabric material have minimum level of surfactant that is required for improving processing so that good bonding strength can be maintained.

The various layers can be bonded together with an adhesive such as hot melt pressure sensitive adhesive (PSA), low density polyethylene (LDPE), polyurethane or acrylics, depending upon the desired bond strength. While an acrylic adhesive provides the best bond strength based on prior art, it is also the most expensive option. Due to their low cost and acceptable level of performance, hot melt adhesives are the preferred bonding agent for the present invention. It is preferred to use 6 to 15 grams/meter² of adhesive between two adjacent layers to obtain a permanent, destructive bond. Hot melt adhesives, which are heat and pressure activated, give a good bond between two layers during the process of manufacture. For this invention, pressure sensitive adhesive sold by H. B. Fuller & Company of Minnesota was preferred.

Roofing felts are used in low slope (roof pitch of 3:12 or lower) and steep slope applications (roof pitch higher than 3:12). Therefore it is essential to provide a top surface that will be anti-skid so that installers of the roof, and materials such as tiles or shingles stored on the rooftop during the installation process do not slide off the roof. Use of a high COF film on the top surface of the laminate enhances skid resistance. Additionally the upper surface of the laminate can be embossed to provide slip resistance in addition to enhancing the aesthetic appeal of the material. Embossing may be achieved during the manufacturing process by imprinting the desired emboss pattern on the composite laminate using a press roller. Another means of achieving an anti-skid surface is by coating the exposed layer with an adhesive (such as an EVA material) in the form of straight lines or in a random pattern (called ‘fiberized’ pattern). Such external treatment provides good skid resistance on the roof. EVA preferred for this invention was manufactured and sold by National Starch and Chemicals Company of New Jersey.

The present invention offers a surface laminate that meet the physical requirements of conventional felt material without the drawbacks associated with roofing felts. The laminate of the present invention is characterized by its light weight, ease of handling, more coverage per roll than conventional felt, very high tensile and tear strengths, good UV properties, anti-skid surfacing, excellent water shedding and water resistant properties, rot and insect resistance, pliability and flexibility at low temperatures, excellent lay flat characteristics, environmental friendliness, relatively low cost, highly reliable, and usability in hot and cold climatic conditions. Moreover the laminate of the present invention allows significant reduction in time and labor during application, resulting in cost savings to the end user. The composite laminate that is the subject of this invention has several unique design features that permit it to be used as an underlayment for APP, SBS and self-adhesive membrane, tiles, metal panels, and shingles.

Another embodiment of the present invention is a laminate that is white in color. This is obtained by using a white color HDPE film on the top surface and a white color PP fabric on the bottom surface.

### BRIEF DESCRIPTION OF THE DRAWINGS

FIG. 1 shows an embodiment of the inventive composite laminate.

FIG. 2 shows a process of manufacture for the composite laminate.

### DETAILED DESCRIPTION OF THE INVENTION

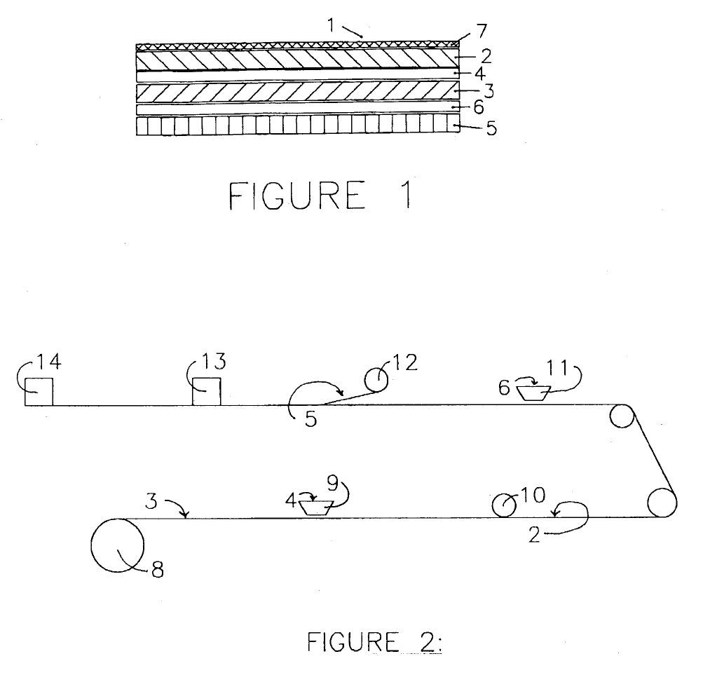

FIG. 1 shows one preferred embodiment of the composite laminate 1. Polyethylene film (HDPE) 2 is laminated to polypropylene scrim 3 using a hot melt adhesive 4. The bottom surface of the polypropylene scrim 3 is then laminated to a polypropylene fabric 5 using a hot melt adhesive 6. Ethyl vinyl acetate (EVA) is applied as an anti-skid coating 7 on the upper side 8 of the polyethylene film 2 to enhance aesthetics and provide anti-slip properties. The preferred embodiment of a composite laminate 1 is a black color high density polyethylene (HDPE) film 2 of 0.8 mil (20 microns) thickness, with built-in ultraviolet inhibitors to prevent UV degradation, laminated to a black color polypropylene scrim 3 using a hot melt adhesive 4 of 6 to 15 grams/meter², which in turn is laminated to a black color polypropylene fabric 5 using a hot melt adhesive 6 of 6 to 15 grams/meter², and the resulting construction is coated with an external layer of an ethyl vinyl acetate (EVA) coating 7. Hot melt adhesive preferred for this invention is made by H. B. Fuller Company under the brand name of hot melt adhesive #2081. Anti-skid adhesive employed in this invention is ethyl vinyl acetate (EVA) due to its excellent adhesion to film surfaces and high temperature resistance. Preferred choice of EVA is sold by National Starch and Chemicals Company under the brand name of EVA #34-5227. Alternatively, the composite can consist of materials that are white in color.

FIG. 2 shows the process of manufacture of a composite laminate, which is a co-extrusion process. Polypropylene scrim 3 is unwound from an unwinding station 8. A bonding adhesive 4 of desired thickness is applied on the top surface of the polypropylene scrim 3 using adhesive applicator 9. HDPE film 2, which is unwound from another unwinding station 10, is laminated to the top surface of the scrim 3. Adhesive coating thickness is precisely controlled using automated systems. After this application, the laminate is pressed using press rollers and the bonding adhesive 4 is allowed to cure by air-cooling. The sheet is now reversed such that the HDPE film is facing downwards and uncoated side of polypropylene scrim 3 is facing upwards. A bonding agent 6 (hot melt adhesive) of desired thickness is applied on the top surface of the polypropylene scrim 3 using adhesive applicator 11. Polypropylene fabric 5, which is unwound from another unwinding station 12, is laminated to the top surface of the scrim 3. Adhesive coating thickness is precisely controlled using automated systems. After this application, the laminate is pressed using press rollers and the bonding adhesive 6 is allowed to cure by air-cooling. The material is slit to the required width using a slitter 13 and wound into rolls of required length at the winder 14. The finished material is usually 60 inches in width and 200 feet in length.

It is preferable that the laminate of the present invention will have a thickness of 0.30 mm and a unit weight of 3.5 lbs/100 square feet. Preferably, the laminate will also have the following: minimum tensile strength of 80 lbs in the longitudinal and transversal directions when tested according to ASTM D2523, minimum elongation to break of 30% in the longitudinal and transversal directions when tested according to ASTM D2523, minimum tear strength of 70 lbs when tested according to ASTM D4533, pass nail sealability test when tested according to ASTM D1970, water vapor transmission value of no greater than 0.50 grams per square meter when tested according to ASTM E96, and retain at least 90% of its original strength after 90 days exposure in a QUV accelerated weatherometer.

What is claimed is:

1. An underlayment for use in roofing applications comprising:
a laminate having at least three layers,
an upper layer of extruded film, the film being made of a material selected from the group consisting of: high density polyethylene film and low density polyethylene film,
a middle layer of lightweight scrim,
a bottom layer of spun bonded polypropylene fabric,
the middle layer being attached to said upper layer by a first adhesive layer, and the middle layer and the bottom layer being connected by a second adhesive layer.

2. The underlayment of claim 1 wherein said upper layer has a non-slip surface.

3. The underlayment of claim 2 wherein said non-slip surface is in the form of embossing on said upper layer.

4. The underlayment of claim 2 wherein said non-slip surface is in the form of coating of ethyl vinyl acetate (EVA) adhesive applied to an upper surface of said upper layer.

5. The underlayment of claim 1 wherein said first adhesive layer is hot melt adhesive, and said second adhesive layer is hot melt adhesive, and each of said first and second adhesive layers applied at a weight of about 6 to 15 grams/meter², as measured prior to curing.

6. The underlayment of claim 1 wherein said scrim is polypropylene:

7. The underlayment of claim 1 wherein said upper layer is comprised of high density polyethylene film having a thickness of about 20 microns.

8. The underlayment of claim 1 wherein said upper layer of high density polyethylene film contains at least one additive to increase coefficient of friction of said film.

9. The underlayment of claim 1 wherein said laminate is coated with an external layer of an ethyl vinyl acetate (EVA) coating.

10. An underlayment for use in roofing applications comprising:
a laminate having at least three layers,
an upper surface comprised of polyethylene film, the film being made of a material selected from the group consisting of: high density polyethylene film and low density polyethylene film, a major portion of the outwardly facing side of said upper layer having non-slip surface characteristics,
a middle layer comprising a polypropylene scrim,
a bottom layer of spun bonded polypropylene fabric,
the middle layer being attached to said upper layer by a first adhesive layer, and
the middle layer and the bottom layer being connected by a second adhesive layer,
a first adhesive layer is hot melt adhesive, and said second adhesive layer is hot melt adhesive, and each of said first and second adhesive layers applied at a weight of about 6 to 15 grams/meter², as measured prior to curing.

11. The underlayment of claim 9 wherein said non-slip surface characteristics are in the form of embossing on said upper layer.

12. The underlayment of claim 9 wherein said non-slip surface characteristics are in the form of coating of ethyl vinyl acetate (EVA) adhesive applied to an upper surface of said upper layer.

13. The underlayment of claim 9 wherein said upper layer is about 20 microns.

14. The underlayment of claim 9 wherein said laminate is coated with an external layer of an ethyl vinyl acetate (EVA) coating.

15. A covering for roofing comprising:
an underlayment having an upper surface of extruded polyethylene film,
a cap sheet comprised of a self-adhering membrane applied directly to the upper surface of said underlayment.

16. A covering for roofing in accordance with claim 15 wherein:
the cap sheet is selected from the group consisting of an SBS modified asphalt self-adhering membrane and an APP modified asphalt self-adhering membrane.

17. A covering for roofing in accordance with claim 15 wherein:
said underlayment is a laminate having at least three layers,
said upper surface is comprised of polyethylene film, the film being made of a material selected from the group consisting of: high density polyethylene film and low density polyethylene film, a major portion of the outwardly facing side of said upper layer having non-slip surface characteristics,
a middle layer comprising a polypropylene scrim,
a bottom layer of spun bonded polypropylene fabric,
the middle layer being attached to said upper layer by a first adhesive layer, and
the middle layer and the bottom layer being connected by a second adhesive layer,
a first adhesive layer is hot melt adhesive, and said second adhesive layer is hot melt adhesive, and each of said first and second adhesive layers applied at a weight of about 6 to 15 grams/meter², as measured prior to curing.
